(19) United States
(12) Patent Application Publication
(10) Pub. No.: US 2007/0295229 A1
(43) Pub. Date: Dec. 27, 2007

(54) Process for embossing a substrate material and substrate material

(76) Inventors: Raymond Sieffert, Rixheim (FR); Markus Luthi, Marthalon (CH); Micha Walk, Schefthausen (CH); Karoline Rosenberger, Osterfingen (CH); Christian Weber, Gallingen (DE)

Correspondence Address: FISHER, CHRISTEN & SABOL, 1725 K STREET, N.W., SUITE 1108, WASHINGTON, DC, 20006, US

(21) Appl. No.: 11/710,418

(22) Filed: Feb. 26, 2007

(30) Foreign Application Priority Data
Mar. 7, 2006 (EP) 06405099.0

(51) Int. Cl. B44C 1/24; B32B 3/00

(52) U.S. Cl. 101/32; 428/156

(57) ABSTRACT

Process for creating embossed substrate materials such as metal foils, plastic films, papers and layered materials or laminates in a printing machine, as desired simultaneous to additional printing using ink. For the embossing of the substrate material a gravure roll as printing plate is provided in a printing station along with an impression roll. The printing elements on the printing plate are transferred to the substrate material as an embossed image. To that end, in the printing station, the substrate material is passed between the gravure roll and the impression roll and thereby embossed. The gravure roll acting as printing plate exhibits the e.g. engraved, depressed or and/or raised printing elements. The substrate material exhibits the embossed pattern and if required mono-colored or multi-colored printing. The embossing may reinforce the colored motif and the embossing may also exhibit functional properties e.g. that of an aid to tearing or dot-like print.

The present invention relates to a process for embossing a substrate material and a substrate material itself.

It is known e.g. to emboss flat substrate material. Embossing stamps or embossing rolls are pressed against the flat substrate material, whereby an image of the embossing stamp or roll is formed in the material. Typical examples of substrate materials are metal foils or metal foils coated with plastic, which are provided with a damask or worm-like embossing.

Foil-embossing, in particular on an industrial scale, is performed preferably between embossing rolls. The foils to be embossed may e.g. be intended for use as packaging materials. This means that the foils to be embossed have already been printed repeatedly or in register with advertisements, texts, logos etc. Embossing the foil in register i.e. continuously in a manner that matches up with the printing, presents some difficulty. Furthermore, the embossing process, and, thereby, the preparation of the embossing rolls is an exceptionally expensive undertaking.

The object of the present invention is to overcome the above mentioned disadvantages and to propose an improved embossing process and a new embossed substrate material for printing on.

That objective is achieved by way of a process according to the invention in that in at least one printing station, the printing elements or the motif on a gravure roll are embossed into the substrate material.

The printing elements or the printing motif on a gravure roll are preferably recessed by means of a printing station in the substrate material in the form of embossing.

Suitable printing stations for carrying out the process are e.g. units in photogravure or flexo-printing machines.

In the case of photogravure or copper-plate printing using a photogravure machine, the motif to be printed is engraved into a gravure roll. The recesses in the form of engraving take up the ink from a trough or ink fountain. The excess ink is wiped off with a blade. An impression roll presses the substrate material against the gravure roll which releases the ink onto the substrate material.

Printing using a flexo-printing machine involves printing under high pressure. The ink is transferred via a screen cylinder on to the raised elements on the printing plate and from that to the substrate material. In the case of flexo-printing the printing plate is a photo-polymer plate, e.g. a pre-fabricated printing means which is mounted on a gravure roll. In the case of flexo-printing the printing elements are raised and project out of the printing plate.

The printing plate for the process according to the present invention is as a rule a gravure roll with the elements or motif to be printed mounted thereon. An impression roll presses onto the gravure roll and the substrate material is passed between the two rolls. When printing with inks, the inks are transferred to the substrate material. Depending on the pressure, whether black-white, three-color printing or multi-color printing, an ink-supplying printing means or a plurality of printing means supplying in particular black, cyan, magenta and yellow, may be installed in the printing machine. To carry out the process according to the invention one or more facilities which apply the embossing to the material to be printed on is provided, in addition to the means for supplying ink—usefully in the printing machine itself. The facility or facilities for applying the embossing are situated ahead of and, advantageously, after the ink-supplying means. In the process according to the invention, e.g. for photogravure printing, the embossing facility is in particular a gravure roll with engraved printing elements. In the printing machine the gravure roll of the facility or facilities that apply the embossing to the substrate material may have the same circumference or diameter as the means for applying the ink, and the said ink-supplying means may be driven by the same power drive or individually by separate drive mechanisms. In another version the roll of the printing facility or facilities that produce the embossed pattern etc. on the substrate material may have a different circumference or diameter than the gravure rolls in the facilities supplying the printing ink, and the printing facilities in that case are driven by separate drive mechanisms—whereby the drive mechanisms, with respect to the circumferential speed of the gravure rolls, are advantageously synchronised.

Especially advantageous in the process according to the invention is that the printing and the embossing take place in the same printing machine by printing stations situated immediately in line with each other. Thus, the application of ink and the embossing are successfully carried out in register—in particular free of any shift or distortion with respect to each other on the substrate material. If the substrate material is not printed with all the colors in the same printing machine or, as here is the case also embossed, then—as a result of need for additional coiling, intermediate storage and uncoiling the material—this can lead to mutual displacement of the individual images and in particular the embossed imaged with respect to the printed images.

In accordance with the present invention the embossing step, as with a printing step, is carried out within the overall printing process likewise using an engraved gravure roll, if necessary with a plurality of gravure rolls, however without applying ink i.e. in a form of blind printing. In the present version, in particular in the printing station or stations for embossing, no ink is deposited on the gravure roll or cylinders. The gravure roll or cylinders applies/apply only the embossing to the substrate material.

The above mentioned printing stations are to advantage operated at room temperature. As a rule the embossing of the substrate material takes place at ambient or room temperature. No supply of energy such as heating to the roll surfaces or the substrate material is normally foreseen during the embossing process. Heating the printing stations or parts thereof, such as heating the gravure roll and/or impression roll and/or the substrate material may be useful for embossing substrate materials that comprise or contain plastic layers. As a result of the heating, the viscosity of the plastic layer can be reduced, thereby influencing the embossing process. The substrate material may also contain reactive layers that, as a result of physical or chemical reaction, change their behavior or condition e.g. harden, polymerise, swell, foam, change their solubility etc. and the change in behavior can, during the embossing, in some cases be halted by supplying energy from the surroundings.

Gravure rolls with engraved printing elements can be manufactured by electro mechanically engraving rolls with a metal surface. For example, a text or an image is read by means of a reading facility and stored in a digital form. The stored data are transferred to the positioning and drive of an engraving tool. The movements of the engraving tool cause the text or image—which is to be printed itself or as scanned points—to be engraved in the surface of the gravure roll as elements for printing, this via removal of material from the surface of the gravure roll.

The gravure roll for applying the inks and for the embossing may in accordance with the present invention e.g. be processed in the same layout-program or image-program—thereby preferably by the same image-processing processor and integral means for mechanical line-screening or engraving, in particular on the same bench. By controlling the depth of engraving, the engraving screen or gravure mesh, by creating cells and separating walls i.e. of the printing elements and support-scan, and by means of the shape of the engraving tool, optimised gravure rolls can be achieved for embossing purposes.

For embossing purposes, it is also possible to provide printing elements on the gravure roll not only in the form of engraving which creates depth but also, alternately, in the form of raised printing elements.

The embossing itself may also be influenced by the material or the surface of the gravure roll or by the impression roll and the hardness or formability of the surface layer of the gravure roll or pressure means, and also by the factors affecting sliding between the rolls and the substrate material.

The printing elements on the gravure roll, e.g. for intaglio or rotogravure printing may be engraved, with respect to the surface of the of the gravure roll, to a depth of 60 to 500 μm, usefully from 60 to 250 μm, advantageously from 80 to 200 μm and in particular from 100 to 200 μm.

The printing elements engraved in the gravure roll may exhibit a reduced supporting grid or be free of a supporting grid. When engraving gravure rolls for ink transfer, a supporting grid that is typical for printing is aimed for in order to achieve optimal uptake, transfer and supply of ink. In accordance with the present invention no ink is transferred by the gravure roll for the purpose of embossing. For that reason the supporting grid, with reference to the area of engraved printing element, may be omitted completely i.e. 100%, or the supporting grid may amount only up to 80% and in particular up to 50% of the supporting area of a supporting grid typical for printing.

With reference to the effective surface of the gravure roll i.e. that part rolling on the substrate material, the engraved printing elements may amount to up to 80% and preferably up to 50%. Usefully, this applies also for the printing elements free of supports.

For example, in the case of flexo-printing or another high pressure printing process, the gravure roll exhibits raised or depressed printing elements. The printing elements in the case of flexo-printing or another high pressure printing process are raised with respect to the surface of the gravure roll and may project by 60 to 500 μm, usefully from 60 to 250 μm, advantageously from 80 to 200 μm and in particular from 100 to 200 μm.

In order for the printing elements of the printing plate to be embossed into the substrate material in the printing station, the said material is passed between the gravure roll and an impression roll. Both rolls roll over the substrate material, normally applying a preset pressure.

The impression roll may have a non-formable, formable or elastic surface layer. The surface of the impression roll is as a rule smooth and features no printing elements. The impression roll may e.g. be a steel roll with a steel surface. In some cases the impression roll may be a steel roll with a surface layer of elastic material such as rubber, or paper, or it may be a rubber roll. The pressure applied by the impression roll on the gravure roll.

The pressure applied by the impression roll on the gravure roll can be set. The pressures employed for the embossing process may e.g. be up to 3 t/m effective roll width, usefully up to 2 t/m, to advantage up to 1 t/m and in particular up to 1.5 t/m, particularly advantageously up to 1 t/m and in particular up to 0.5 t/m. The minimum pressures may be 0.2 t/m effective roll width and advantageously 0.4 t/m typical roll widths range from 200 mm to 5600 mm and preferably from 500 to 1200 mm. In some cases an underlay may be employed in the printing station.

The material to be printed on is embossed between the pair of rolls i.e. the gravure roll and the impression roll with the image according to the printing elements on the gravure roll. The depth of embossing on the material to be printed on can be varied by the depth of the engraving in the gravure roll, by the control of the pressure applied by the impression roll on the gravure roll, and by the characteristics of the material in the surface layer of the impression roll.

In a version of choice the impression roll may also be a gravure roll and exhibit printing elements. Such an impression roll in the form of a gravure roll may in particular exhibit the negative image or the printing elements in negative form, and the printing elements of the gravure roll and the negative printing elements of the impression roll act in unison on the substrate material. That means that the impression roll is likewise a gravure roll with the embossed negative of the printing elements of the other gravure roll. The described impression roll or other gravure roll represents therefore the counter-image. In particular the raised parts of the stamped motif on one gravure roll surface engages in the engraved or raised part of the motif in the surface of the other gravure roll. The substrate material passing between the two rolls is correspondingly deformed in a pronounced manner and provided with the desired embossing.

Is also possible for two different gravure rolls to act on the substrate material in separate stations in such a manner that one gravure roll provides the substrate material with embossing in one direction and the other gravure roll provides it with embossing in the other direction. Embossing from both sides may also be achieved by turning the substrate material to be printed on by means of a turret mechanism in the printing machine.

It is also possible to pass the substrate material between the different gravure rolls against the same impression roll or against separate impression rolls and to emboss different images or motifs in succession one after the other, super-imposed or stepped in depth.

Finally, it is also possible in the process according to the invention to employ the printing station only for embossing purposes, and not to employ any ink-supplying stations. This application is of great interest for the production of substrate materials in general and of substrate materials which are incompatible for printing inks, toners, solvents and the like, but can still be embossed.

According to the present invention it is possible in the printing station to emboss the substrate material e.g. with the printing elements or the motif on the gravure roll as a raised pattern, as three-dimensional profiles or as patterns that may be used in holograms, or dot-like or Braille print, or as a form of weakness, as punched holes, perforations or folding lines. It is understandable that the different types of embossing in a printing station may be undertaken by the same gravure roll on the same material in any desired combination.

The embossing produced on the substrate material in the form of elevated or depressed areas in one or more printing stations by the gravure roll and the impression roll may be carried out in a further printing station with smooth gravure and impression rolls to limit the depth of embossing or to smooth or moderate the embossed structure. By controlling the pressure applied it is possible to adjust the desired depth of embossing.

The present invention relates also to a material for printing on that contains an embossed motif.

Embossed substrate material according to the present invention are those with embossing that has been applied in a printing station with the printing elements or motif of a printing plate, in particular a printing plate on or mounted on a gravure roll.

Examples of substrate material according to the invention are those whose motif in the form of embossing projects from the surface of the said material by 20 to 500 μm, usefully to 250 μm, advantageously 70 to 200 μm and in particular 80 to 200 μm. As a rule the motif projects from one side of the said material. If the embossing has been carried out between two gravure rolls or in both directions, then the embossing may project alternately to the given height on each side of the said material.

Substrate materials may be e.g. film-shaped materials. Examples thereof are metal foils such as steel foils and in particular aluminum foils, plastic films, papers or cardboard. Further examples are composite films, layered materials and laminates made up of plastics and metal foils, plastics and paper, plastics and cardboard, metal foils and paper or plastics, metal foils and paper or out of metal foils, plastics and cardboard.

If plastic films are employed as substrate material or part thereof, then suitable plastic films are e.g. of polyvinylchloride, polyamides, polyesters, poly-carbonates, polyolefins, in particular polyethylene or polypropylene, polystyrene etc. The plastic films may also be in the form of copolymers. The plastic films may also be laminates made up of two or more layers joined by lamination, co-extrusion etc. The thickness of the individual plastic films or plastic layers may be from 12 to 250 μm, usefully from 15 to 100 μm and advantageously from 20 to 50 μm.

The films may be transparent, translucent, opaque or colored. The plastic films may be sealable or provided on one or both sides with a sealing layer or a sealing lacquer.

If foils of metal, such as aluminum, are employed as or in substrate material, then their thickness may be from 12 to 200 μm, usefully 15 to 100 μm and advantageously from 20 to 50 μm. The aluminum foils may be made of pure aluminum of a purity of 99% to 99.5%, or an aluminium alloy. The condition of the aluminium may be soft to hard, or hard-rolled. The aluminium foils may be brushed on one or both sides, etched, colored, anodised, neutralised, coated with a protective coating and/or lacquered.

Further substrate materials are laminates of metal foils, plastic films, or plastic films and metal foils. Examples are laminates of an aluminum foil, which is coated or laminated on one or both sides with polyester films or polyolefin films. Suitable substrate materials are also laminates or layers of cardboard or paper and at least one plastic layer. Such materials are known in the field as Mixpap. As required, adhesives, primers and barrier layers etc. may be provided between the individual layers of the laminates, and barrier layers and sealing layers etc. may be provided on the outward-facing sides.

Other materials for printing on are papers with unit area weights of 80 to 300 g/m² and usefully from 100 to 270 g/m². The papers may be simply or bright laminated on one or both sides.

The embossed printed motif may be an embossed or raised pattern on the substrate material. The embossed pattern may be any sequence of numbers or letters, graphic elements, pictures, any repetitive pattern e.g. ornaments, Damask or Paisley patterns etc. Patterns capable of holographic imagining are also possible. A dot-like or Braille form of writing may also be produced on the said material. According to the invention it is also possible to create very fine embossed images such as picture-type motifs or writing on the substrate material viz., in picture or writing form of the size of 0.5 mm. The present invention includes also substrate materials with embossing thereon such as picture-type motifs or writing of a magnitude in height of 0.5 mm and smaller.

The embossed image may be a weakness, holes and/or perforations. Of course all of the above mentioned embossing may be provided on a material individually or in any desired combination.

In the process according to the present invention the motifs created using inks and the embossing are produced on the substrate material in at least one and in particular the same printing machine. The printing plates, such as the gravure roll with the engraved printing elements may be manufactured in the same simple and cost-favorable manner both for the ink-supplying plates as for the embossing plates and can be mounted or changed as easily and as quickly in the printing machine. This enables fast, cost favorable change over of both the printed image and the embossing for the material to be printed on.

The materials manufactured in accordance with the invention find application e.g. as packaging materials for all kinds of items, including foodstuff packaging, packaging used in medicine and pharmacy, packaging for medicaments, packaging for smokers utensils such as packaging for cigarettes, cigars or loose tobacco. Further applications are wallpapers and other large area decoration means. If the substrate materials are processed into forms of packaging, then the embossing can be used as non-forgeable evidence of safety, origin and originality. The embossing can complement or emphasise the printed image or motif by way of optically raised elements. During the printing process the substrate material may be provided e.g. with weakness features e.g. opening means or tear lines such as perforations or dot-like features or Braille, in particular in register i.e. accurately defined on the substrate material which is later to be used as a packaging material. Printed images and optically raised elements and/or weakness features may be superimposed on each other. As the individual elements are applied to or in the substrate material in the same printing station, the position of the elements with respect to or on each other can be predetermined and, after leaving the station in question the elements are situated beside or on top of each other in the predetermined positions on the substrate material. For example, substrate material that are to be used as packaging materials may contain weakness features such as perforations as tearing lines or as an aid to tearing the packaging open, and related images such as indications for such tear lines; furthermore, it is possible to produce forms of packaging of high quality with respect to the superposition of printed images, optically recognisable raised features and tear lines for easy opening in the simplest possible manner.

### EXAMPLES

Various substrate materials are passed between a gravure roll and an impression roll in a printing station, thereby applying the printed image on the gravure roll to the substrate materials in question. The image for printing is engraved to a depth (gravure depth) of 70 and 170 μm in the gravure roll. The impression roll has a smooth, non-embossed surface. In a trials the feeding rate of the substrate material is 20 m/sec². In various trials the substrate material was embossed with an under-layer between the gravure roll and the impression roll, mainly a paper having a weight per unit area of 270 g/m². The under-layer faces the impression roll; the substrate material faces the gravure roll. The image embossed into the said substrate material is evaluated, whereby sharply reproduced or clearly visible embossed images are to be seen as optically raised patterns in the material.

| | Gravure- | | | | |
|---|---|---|---|---|---|
| | depth in | Substrate Material, | Roll | Under- | |
| Nr. | μm | thickness in μm | pressure | layer | Result |
| 1 | 70 | Aluminium foil, | 1.5 t | no | ++ |
| | | hard, 20 μm | | | |
| 2 | 70 | Paper, 270 g/m² | 2 t | no | ++ |
| 3 | 120 | Aluminium foil, | 1.5 t | yes | +++ |
| | | hard, 20 μm | | | |
| 4 | 120 | Aluminium foil, | 1.5 t | no | +++ |
| | | hard, 20 μm | | | |
| 5 | 120 | Laminate: Al 30 | 1.5 t | no | +++ |
| | | μm/ PET 12 μm 1) | | | |
| 6 | 120 | Aluminium foil, | 1.5 t | no | +++ |
| | | hard, 20 μm | | | |
| 7 | 120 | Aluminium foil, | 1.5 t | yes | +++ |
| | | hard, 20 μm | | | |
| 8 | 120 | Aluminium foil, | 2 t | no | +++ |
| | | hard, 20 μm | | | |
| 9 | 120 | Aluminium foil | 2 t | yes | +++ |
| | | hard, 20 μm | | | |

1) Laminate: Al 30 μm/PET 12 μm = laminate of 30 μm thick aluminium foil and a 12 μm thick polyester foil
Sharply defined embossed image +++
Clearly defined embossed image ++
Recognisable embossed image +

1. A process for embossing a substrate material for printing on, wherein, in at least one printing station the substrate material is embossed with the printing elements or motif of a printing plate.

2. The process according to claim 1 wherein the printing plate is a gravure roll with engraved printing elements in the form of recesses.

3. The process according to claim 1, wherein the printing elements in the gravure roll are engraved, with respect to the surface of the gravure roll, to a depth of 60 to 500 μm, usefully from 60 to 250 μm, advantageously from 80 to 200 μm and in particular from 100 to 200 μm.

4. The process according to claim 1, wherein the printing elements are engraved in the gravure roll with a reduced support grid or without a support grid.

5. The process according to claim 1, wherein the printing plate is a gravure roll with a printing plate having projecting printing elements.

6. The process according to claim 1, wherein the printing plate on the gravure roll contains printing elements which, with respect to the surface of the gravure roll project from 60 to 500 μm, usefully from 60 to 250 μm, advantageously from 80 to 200 μm and in particular from 100 to 200 μm.

7. The process according to claim 1, wherein in the printing station the substrate material is embossed with the printing elements in the printing plate, whereby the substrate material is embossed between the gravure roll and the impression roll, and the impression roll exhibits the negative printing elements of the printing plate, and the printing elements of the gravure roll and negative printing elements of the impression roll are impressed simultaneously in the substrate material.

8. The process according to claim 1, wherein in the printing station the printing elements or the motif on the printing plate are impressed as embossed image in the form of a raised pattern, as a pattern capable for holographic purposes or as dot-like or Braille-type print.

9. The process according to claim 1, wherein in the printing station the image on the printing plate is embossed in the substrate material as weakness in the form of holes or perforations.

10. A substrate material, wherein the substrate material contains an embossed motif.

11. The substrate material according to claim 10, wherein the embossed motif is created in a printing station by means of printing elements or the motif is created on a printing plate.

12. The substrate material according to claim 10, wherein the motif projects 20 to 500 μm, usefully from 50 to 250 μm, advantageously from 70 to 200 μm and in particular from 80 to 200 μm from the surface of the substrate material.

13. The substrate material according to claim 10, wherein the substrate material contains or comprises a metal foil, in particular a steel foil or an aluminum foil, a plastic film, a paper, a cardboard or composite films of plastics, of plastics and metal foils, of plastics and paper, of plastics and cardboard, of metal foil and paper, of plastics, metal foils and paper or of plastics, metal foils and cardboard.

14. The substrate material according to claim 10, wherein the embossed negative image is in the form of embossing, a raised pattern, a pattern capable for holographic purposes and/or a dot-like or Braille print.

15. The substrate material according to claim 10, wherein the motif embossed in the substrate material is a weakening, holes and/or perforation.

16. The process according to claim 2, wherein the printing elements in the gravure roll are engraved, with respect to the surface of the gravure roll, to a depth of 60 to 500 μm, usefully from 60 to 250 μm, advantageously from 80 to 200 μm and in particular from 100 to 200 μm.

17. The process according to claim 16, wherein the printing elements are engraved in the gravure roll with a reduced support grid or without a support grid.

18. The process according to claim 5, wherein the printing plate on the gravure roll contains printing elements which, with respect to the surface of the gravure roll project from 60 to 500 μm, usefully from 60 to 250 μm, advantageously from 80 to 200 μm and in particular from 100 to 200 μm.

19. The process according to claim 17, wherein the printing plate on the gravure roll contains printing elements which, with respect to the surface of the gravure roll project from 60 to 500 μm, usefully from 60 to 250 μm, advantageously from 80 to 200 μm and in particular from 100 to 200 μm.

20. The process according to claim 5, wherein in the printing station the substrate material is embossed with the printing elements in the printing plate, whereby the substrate material is embossed between the gravure roll and the impression roll, and the impression roll exhibits the negative printing elements of the printing plate, and the printing elements of the gravure roll and negative printing elements of the impression roll are impressed simultaneously in the substrate material.

21. The process according to claim 19, wherein in the printing station the substrate material is embossed with the printing elements in the printing plate, whereby the substrate material is embossed between the gravure roll and the impression roll, and the impression roll exhibits the negative printing elements of the printing plate, and the printing elements of the gravure roll and negative printing elements of the impression roll are impressed simultaneously in the substrate material.

22. The process according to claim 5, wherein in the printing station the printing elements or the motif on the printing plate are impressed as embossed image in the form of a raised pattern, as a pattern capable for holographic purposes or as dot-like or Braille-type print.

23. The process according to claim 21, wherein in the printing station the printing elements or the motif on the printing plate are impressed as embossed image in the form of a raised pattern, as a pattern capable for holographic purposes or as dot-like or Braille-type print.

24. The process according to claim 5, wherein in the printing station the image on the printing plate is embossed in the substrate material as weakness in the form of holes or perforations.

25. The process according to claim 23, wherein in the printing station the image on the printing plate is embossed in the substrate material as weakness in the form of holes or perforations.

26. The substrate material according to claim 11, wherein the motif projects 20 to 500 μm, usefully from 50 to 250 μm, advantageously from 70 to 200 μm and in particular from 80 to 200 μm from the surface of the substrate material.

27. Substrate material according to claim 26, wherein the substrate material contains or comprises a metal foil, in particular a steel foil or an aluminum foil, a plastic film, a paper, a cardboard or composite films of plastics, of plastics and metal foils, of plastics and paper, of plastics and cardboard, of metal foil and paper, of plastics, metal foils and paper or of plastics, metal foils and cardboard.

28. The substrate material according to claim 27, wherein the embossed negative image is in the form of embossing, a raised pattern, a pattern capable for holographic purposes and/or a dot-like or Braille print.

29. The substrate material according to claim 28, wherein the motif embossed in the substrate material is a weakening, holes and/or perforations.
